(19) United States
(12) Patent Application Publication
(10) Pub. No.: US 2010/0088493 A1
(43) Pub. Date: Apr. 8, 2010

(54) IMAGE PROCESSING DEVICE AND DATA PROCESSOR

(75) Inventors: Yoshitaka TAKAHASHI, Hitachi (JP); Shoji MURAMATSU, Hitachinaka (JP); Tetsuaki NAKAMIKAWA, Hitachi (JP); Hiroyuki HAMASAKI, Kodaira (JP); So OTSUKA, Saitama (JP)

Correspondence Address: BRUNDIDGE & STANGER, P.C., 1700 DIAGONAL ROAD, SUITE 330, ALEXANDRIA, VA, 22314, US

(73) Assignee: Renesas Technology Corp.

(21) Appl. No.: 12/566,123

(22) Filed: Sep. 24, 2009

(30) Foreign Application Priority Data
Oct. 3, 2008 (JP) JP2008-258039

(51) Int. Cl. G06F 9/302; G06F 12/00

(52) U.S. Cl. 712/221; 711/154; 711/E12.001; 712/E09.017

(57) ABSTRACT

A restriction is given to the calculation function for image processing achieved by the hard-wired system and the memory access control of a buffer memory, and a range of the restriction is made variable by a program control and others. Data is inputted to the buffer memory from the outside with a restriction of “in units of memory line”, and the number of memory lines and positions of the same to which data is inputted can be programmable by the control circuit. The arithmetic circuit is subjected to the restriction of performing the calculation in units of data of one or plural memory lines supplied from the buffer memory, and a calculation processing content in units of calculation processing for the units of data can be programmably assigned by the control circuit.

### CROSS-REFERENCE TO RELATED APPLICATION

The present application claims priority from Japanese Patent Application No. JP 2008-258039 filed on Oct. 3, 2008, the content of which is hereby incorporated by reference into this application.

### TECHNICAL FIELD OF THE INVENTION

The present invention relates to a data processing technique for image processing. More particularly, the present invention relates to a technique effectively applied to an image processing device and a data processor performing image processing with using, for example, an arithmetic circuit and a buffer memory such as a line memory.

### BACKGROUND OF THE INVENTION

Progress has been made on the studies of various image processing algorithms, and new algorithms, improvements of conventional algorithms and the like have been constantly reported. For handling these new algorithms, the modification of a program of an image processing calculation is considered. This is achieved by an image processing architecture including a DSP (digital signal processor) and/or a certain multi-parallel arithmetic unit, and the new algorithms can be handled to some extent by programming. The architecture capable of handling the new algorithms by a program is generally inferior to a hard-wired system in power consumption and/or a performance/area ratio (cost performance). The hard-wired system is more advantageous for an embedded controller in terms of power consumption and required high performance/area ratio (cost performance). However, there is an issue that the hard-wired system is difficult to handle a new architecture created after hardware design. An invention aiming to increase the degree of freedom in calculation such as writing calculation data back to a line memory based on the hard-wired system is disclosed in Japanese Patent Application Laid-Open Publication No. 10-340340 (Patent Document 1).

### SUMMARY OF THE INVENTION

However, the present inventors have found out that it is difficult to fully make use of the advantages of both of the hard-wired system and the stored program system by the technique disclosed in Patent Document 1 aiming to increase the degree of freedom in calculation. That is, although high performance can be achieved with using minimum necessary hardwares when the image processing functions are configured with dedicated hardwares achieved by the hard-wired system, the processing except for the calculation algorithms planned in the design stage cannot be performed in nature because the control and function are implemented as a circuit when the hard-wired system is used for the access control of a memory and/or the calculation processing for image processing. Also, in the case of a system in which access control of a memory and calculation processing are described by a program such as a general-purpose processor, since the degree of freedom is given to the access to the memory in order to allow various calculation algorithms, the circuit is complicated and its circuit scale becomes large. As a result, in the program-description system having a large degree of freedom, its circuit scale has to be increased compared with the hard-wired system even when achieving the same performance.

A preferred aim of the present invention is to provide an image processing device having a small circuit scale and a superior processing performance.

Another preferred aim of the present invention is to provide an image processing device and a data processor capable of maintaining the efficiency of the hard-wired system and easily achieving various image processing functions.

The above and other preferred aims and novel characteristics of the present invention will be apparent from the description of the present specification and the accompanying drawings.

An outline of typical one of the inventions disclosed in the present application will be briefly described as follows.

That is, restriction is given to the calculation function for image processing achieved by the hard-wired system and the memory access control of a buffer memory, and a range of the restriction is made variable by a program control and others. By this means, the hard-wired circuits can be controlled so as to maintain the efficiency of the hard-wired system and achieve various image processing functions.

The effects obtained by typical aspects of the present invention disclosed in the present application will be briefly described below.

That is, more complicated calculation algorithms can be achieved by variably using calculation algorithms implemented highly efficiently with the hard-wired system, so that an image processing device having a small circuit scale and a superior processing performance can be provided.

### BRIEF DESCRIPTIONS OF THE DRAWINGS

FIG. 1 is a block diagram illustrating an image processing device according to the present invention;

FIG. 2 is a block diagram illustrating a data processor according to the present invention;

FIG. 3 is a block diagram illustrating a configuration of a system register;

FIG. 4 is a block diagram illustrating a configuration of a microcontroller;

FIG. 5 is a block diagram illustrating a configuration of a synchronous circuit;

FIG. 6 is a block diagram illustrating a configuration of an input circuit;

FIG. 7 is a block diagram illustrating a configuration of a line memory;

FIG. 8 is a block diagram illustrating a configuration of an arithmetic circuit;

FIG. 9 is a block diagram illustrating a configuration of an output circuit;

FIG. 10 is an explanatory diagram extracting and illustrating a command set of the microcontroller;

FIG. 11 is an explanatory diagram illustrating register functions usable by a program of the microcontroller;

FIG. 12 is an explanatory diagram illustrating a schematic processing flow in an image recognition processing as one example of a processing using the image processing device;

FIG. 13 is a memory map diagram illustrating a memory space of the data processor;

FIG. 14 is an explanatory diagram illustrating a status of use of the line memory in the image processing of FIG. 12; and

FIG. 15 is a flow chart illustrating an operation of the image recognition processing by the image processing device.

### DESCRIPTIONS OF THE PREFERRED EMBODIMENTS

### 1. Outline of Embodiment

First, an outline of a typical embodiment of the invention disclosed in the present application will be described. In the following outline description of the typical embodiment, reference symbols attached with parentheses to be referenced in the drawings show only those included in the concepts of the components to which the reference symbols are attached.

[1] An image processing device (201) according to the present invention includes: an input circuit (104) for reading data to be a calculation target from an outside and inputting it; a buffer memory (105) temporarily retaining data inputted by the input circuit; an arithmetic circuit (106) performing a calculation processing of data outputted from the buffer memory; an output circuit (107) for writing a calculation result of the arithmetic circuit back to the outside or the buffer memory; and control circuits (101, 102). The buffer memory has a plurality of memory lines (MLi) which are logically in series as memory regions, and input data can be written to the memory line assigned by the control circuit and the written data can be read therefrom. The arithmetic circuit repeatedly calculates data of one or plural memory lines outputted from the buffer memory in accordance with a processing content assigned by the control circuit in units of each calculation processing. Data of the assigned memory line is outputted from the buffer memory to the arithmetic circuit in units of each memory line by the control circuits.

According to the above description, data is inputted to the buffer memory from the outside with a restriction of “in units of memory line”, and the number of memory lines and positions of the same to which data is inputted can be programmable by the control circuit. The arithmetic circuit is subjected to the restriction of performing the calculation in units of data of one or plural memory lines supplied from the buffer memory, and a calculation processing content in units of calculation processing for the units of data can be programmably assigned by the control circuit. Therefore, these hard-wired circuits can be controlled by the control circuits so as to maintain the efficiency of the hard-wired system and achieve various image processing functions.

[2] In the image processing device of the item 1, the control circuit instructs one or plural memory lines to which the data inputted from the outside is written, and instructs the memory line to which the calculation result of the arithmetic circuit is written back.

[3] A data processor according to the present invention includes: an image processing device (201); and a central processing unit (208) performing control of the image processing device and access control to a memory. The image processing device has: an input circuit for reading data to be a calculation target from the memory and inputting it; a buffer memory temporarily retaining data inputted by the input circuit; an arithmetic circuit performing a calculation processing of data outputted from the buffer memory; an output circuit for writing a calculation result of the arithmetic circuit back to the memory or the buffer memory; and control circuits. The buffer memory has a plurality of memory lines which are logically in series as memory regions, and input data can be written to the assigned memory line and the written data can be read therefrom. The arithmetic circuit repeatedly calculates data of one or plural memory lines outputted from the buffer memory in accordance with an assigned processing content in units of each calculation processing. The control circuit instructs one or plural memory lines to which data inputted from the input circuit is written, instructs the calculation processing content of the arithmetic circuit, instructs the memory line to which a calculation result of the arithmetic circuit is written back, and instructs a memory line supplying data from the buffer memory to the arithmetic circuit.

Similar to the above description, these hard-wired circuits can be controlled by the control circuits so as to maintain the efficiency of the hard-wired system and achieve various image processing functions.

[4] In the data processor of the item 3, the central processing unit references a calculation result of the image processing device from the memory during a calculation operation of the image processing device.

[5] A data processor according to an another point of view of the present invention includes: an image processing device; and a central processing unit performing control of the image processing device and access control to a memory. The image processing device has: an input circuit for reading data to be a calculation target from the memory and inputting it; a buffer memory temporarily retaining data inputted by the input circuit; an arithmetic circuit performing a calculation processing of data outputted from the buffer memory; an output circuit for writing a calculation result of the arithmetic circuit back to the memory or the buffer memory; and control circuits. The buffer memory has a plurality of memory lines (MLi) which are logically in series as memory regions, and input data can be written to the memory line assigned by the control circuit and the written data can be read therefrom. The arithmetic circuit can parallelly calculate data of the plurality of memory lines read from the buffer memory in accordance with a processing content assigned by the control circuit. The control circuit controls the arithmetic circuit to repeatedly execute a first calculation for data in a first memory region (MLi to MLi+4) corresponding to the plurality of memory lines of the buffer memory sequentially in units of each data processing, and when calculation results of the repeatedly-executed first calculations are stored in memory lines in a second memory region (MLj to MLj+2) corresponding to the plurality of memory lines of the buffer memory, the control circuit replaces data of a memory line where the data memory is performed first in the first memory region, and then, controls the arithmetic circuit to repeatedly execute the first calculation again.

Similar to the above description, these hard-wired circuits can be controlled by the control circuits so as to maintain the efficiency of the hard-wired system and achieve various image processing functions. Further, it is possible to achieve a calculation algorithm, in which the first calculation is continued while updating the data used for the first calculation in units of memory line in addition to writing the results of the first calculations using the data stored in the buffer memory back to the buffer memory.

[6] In the data processor of the item 5, when required calculation results are acquired in the memory lines in the second memory region, the control circuit controls the arithmetic circuit to repeatedly execute a second calculation for data in the second memory region sequentially in units of each data processing, and to store calculation results of the repeatedly-executed second calculations in a memory line in a third memory region (MLk) of the buffer memory.

By this means, it is possible to achieve a calculation algorithm, in which the second calculation is performed with further using the first calculation results written back to the buffer memory and results of the second calculations are further written back to the buffer memory to get ready for a next calculation.

[7] In the data processor of the item 6, when required calculation results are acquired in the memory line in the third memory region, the control circuit controls the arithmetic circuit to repeatedly execute a third calculation for data in the third memory region, and to store calculation results of the repeatedly-executed third calculations in a memory line in a fourth memory region of the buffer memory.

By this means, it is possible to achieve a calculation algorithm, in which the third calculation is performed with further using the second calculation result written back to the buffer memory and results of the third calculations are further written back to the buffer memory to get ready for a next processing.

[8] In the data processor of the item 7, when required calculation results are acquired in the memory line in the fourth memory region, the control circuit controls a writing of the calculation results to the memory by instructing the output circuit. By this means, overhead caused by data transfer between the image processing device and the memory can be suppressed.

[9] In the data processor of the item 6, when required calculation results are acquired in the memory line in the third memory region, the control circuit controls the arithmetic circuit to repeatedly execute a third calculation for data in the third memory region, and controls the output circuit to output the calculation results of the repeatedly-executed third calculations to the outside.

[10] In the data processors of any one of the items 5 to 9, the control circuit has a microcontroller, a control register, and a synchronous circuit. The microcontroller performs a control to execute a program to write control data to the control register. The synchronous circuit controls the writing to the control register in accordance with operation statuses of the input circuit and the arithmetic circuit. The control register outputs control signals to the input circuit, the buffer circuit, the arithmetic circuit, and the output circuit in accordance with the written control data.

[11] In the data processor of the item 10, control information for assigning a memory line to which data is loaded from the input circuit, control information for assigning a memory line to which data is loaded from the output circuit, control information for assigning the number of memory lines to which data is loaded, control information for assigning a memory line from which data is outputted, and control information for assigning the number of memory lines from which data is outputted are set to the control register.

[12] In the data processor of the item 7, the first calculation is a convolution operation for smoothing image data of the plurality of memory lines, with using m×n pixels of data as a unit of data processing.

[13] In the data processor of the item 12, the second calculation is a filter operation for edge-emphasizing the image data of the plurality of memory lines, which has been subjected to the convolution operation, with using i×j pixels of data as a unit of data processing.

[14] In the data processor of the item 13, the third calculation is an operation for binarizing the image data which has been subjected to the filter operation.

### 2. Details of Embodiment

The embodiment will be further described in detail. Hereinafter, an embodiment of the present invention will be described in detail with reference to the accompanying drawings. Note that components having the same function are denoted by the same reference symbols throughout the drawings for describing the embodiment, and the repetitive description thereof will be omitted.

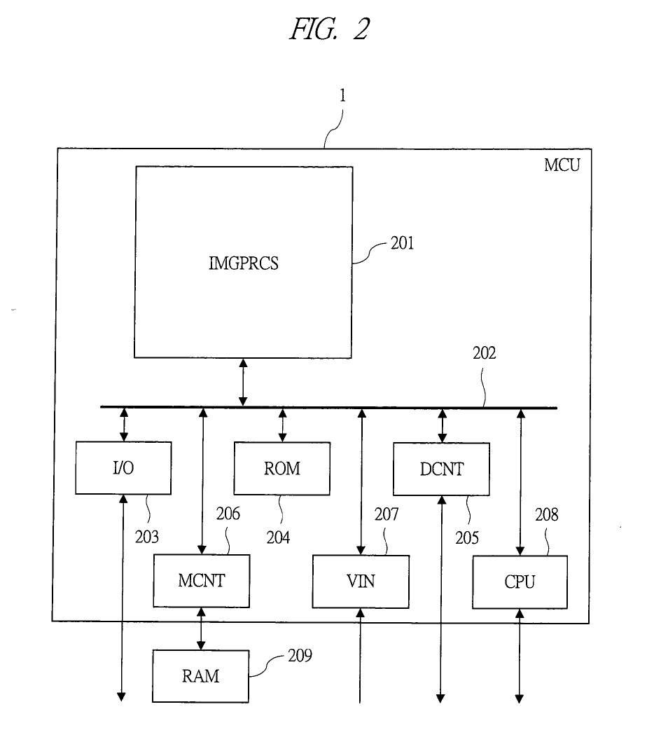

FIG. 2 illustrates a data processor according to the present invention. Although not particularly limited, a data processor (MCU) 1 illustrated in this figure is formed on one semiconductor substrate made of single crystal silicon or the like by a manufacturing technique of a complementary MOS integrated circuit and the like, and it is configured as, for example, a system-on-chip LSI.

In FIG. 2, a reference symbol 201 denotes an image processing device (IMGPRCS), a reference symbol 202 denotes a bus in chip, a reference symbol 203 denotes a peripheral interface (I/O), a reference symbol 204 denotes a read-only memory (ROM), a reference symbol 205 denotes a display output circuit (DCNT), a reference symbol 206 denotes a main memory interface (MCNT), a reference symbol 207 denotes a video input circuit (VIN), a reference symbol 208 denotes a central processing unit (CPU), and a reference symbol 209 denotes a main memory (RAM). The main memory 209 may be on the chip of the data processor 1.

The image processing device 201 is a hardware performing image processing at high speed, and its details will be described later.

The bus in chip 202 is an internal bus illustrated by one hierarchy level for convenience, and it is used for transmitting data, address and/or others between respective internal circuit modules and can be configured by, for example, a split transaction bus or the like.

The peripheral interface 203 is a circuit controlling input and output of signals in an embedded system using the data processor 1.

The read-only memory 204 is a dedicated memory for reading and stores a boot program of the system, a setting required for the system, and the like.

The display output circuit 205 is a circuit used for the connection to a display device such as a liquid crystal display.

The main memory interface 206 is a memory controller controlling the main memory configured by a synchronous DRAM or the like.

The video input circuit 207 receives image data from an image input camera or the like and transfers its signal to the image processing device 201 via the bus in chip 202.

The CPU 208 is a circuit which is responsible for the overall control of the data processor 1, and the CPU 208 also performs various settings to the image processing device 201. Although not illustrated, it fetches a command of the ROM 204, decodes the fetched command, and performs a calculation processing, an access processing, and/or others for executing the command in accordance with its decoded result.

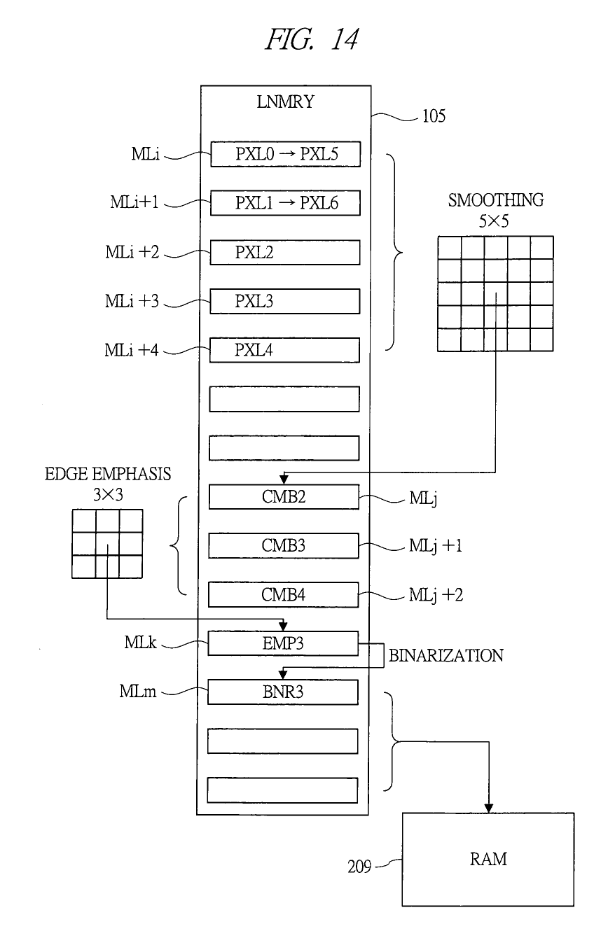

The image data used for the image processing is stored in, for example, the main memory 209. When the image data is inputted from a camera, it is stored in the main memory 209 via the video input circuit 207. Also, when the image data is inputted from other than the camera, it is inputted from an external interface such as the peripheral interface 203 to be stored in the main memory 209. The stored image data is stored as a block of data like that in a memory space illustrated in FIG. 13. This “block” does not mean a physical address but a state of being logically handled as a block of data, and continuous image data is stored in a series of addresses. The image data inputted from the camera is written by the video input circuit 207 to an address assigned by the main memory 209. The CPU 208 determines the address where the data is written with using a program, and the address is previously set in the video input circuit 207.

When the image processing is performed, two processing types are possible such as a case of processing by the CPU 208 and a case of processing by the image processing device 201. The case of processing by the CPU 208 is performed with using a calculation command, a transfer command, and/or the like included in its command set, and its operation is not different from that of a normal general-purpose CPU, and therefore, descriptions of its details are omitted here. In the case of processing by the image processing device 201, the image data of the main memory 209 is transferred to the image processing device 201 via the main memory interface 206. Results of the image processing are written back to the main memory 209 so that the CPU 208 and/or the display output circuit 205 can access the results. These settings are also controlled in accordance with a calculation program of the CPU 208. More specifically, a processing of determining what address of the main memory 209 an image data to be processed is stored in, how the image processing device 201 processes, and what address of the main memory 209 the data is written back to is performed by the CPU 208 in accordance with the operation program.

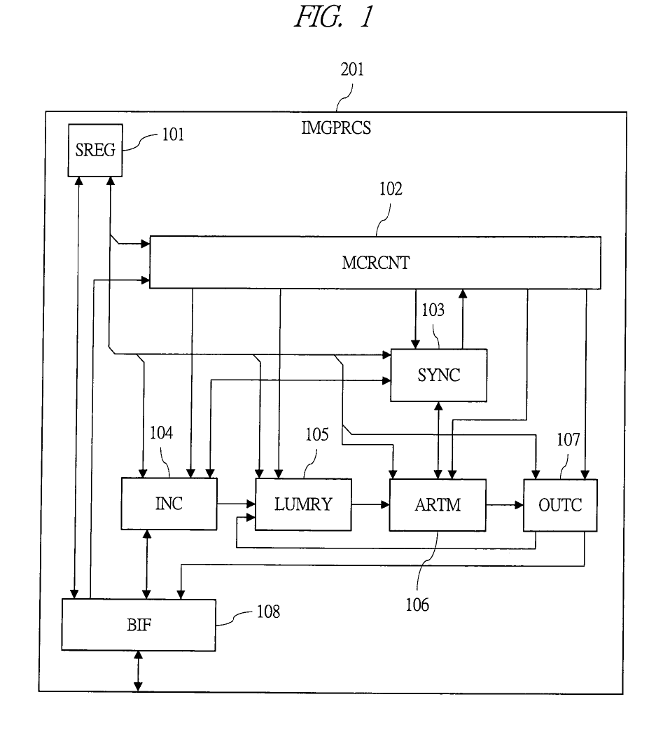

FIG. 1 illustrates one example of the image processing device 201. The image processing device 201 is made up of: a system register (SREG) 101 defining an operation; a microcontroller (MCRCNT) 102 controlling the operation of the image processing device 201 by a program; a synchronous circuit (SYNC) 103 controlling a timing of acquiring data required for the image processing and a timing of switching image processing functions; an input circuit (INC) 104 reading the image data from the main memory 209; an output circuit (OUTC) 107 writing the processing result back to the main memory 209; a line memory (LNMRY) 105 serving as a buffer memory for temporarily recording the image data required for the processing; an arithmetic circuit (ARTM) 106 mainly configured by the hard-wired logic system and enabling the image processing at high speed; and a bus interface (BIF) 108. The bus interface 108 is an interface for connecting the image processing device 201 to the bus 202.

The image processing device 201 performs the processing based on information set in the system register 101. Information required for operations of other internal circuits 102 to 108 is set in the system register 101, and their set values are outputted to the respective internal circuits 102 to 108 to control the respective operations. Also, the system register 101 has functions of receiving and retaining predetermined information from the internal circuits 102 to 108 for monitoring the calculation result and/or the operation status of the image processing. In the system register 101, the control data can be set by the accessing from the CPU 208 via the bus interface 108 in FIG. 2, so that the CPU 208 controls the image processing device 201 via the system register 101.

One example of the image processing in the image processing device 201 will be described. Here, it is assumed that an image data A in FIG. 13 is processed and its processing result is written as an image data C.

The CPU 208 sets a data acquisition to the input circuit 104 via the system register 101. The setting defines a position of the image data A in the memory space. Contents of the image processing are set in the system register 101, and the contents are transmitted to the arithmetic circuit 106. The line memory 105 between the input circuit 104 and the arithmetic circuit 106 plays a role of retaining data inputted from the input circuit 104 and supplying data required for the arithmetic circuit 106. For example, in a case of a smoothing filter having 3×3 window, total 9 pieces of data for the pixels arranged longitudinally and laterally are required for processing image data to be a processing target. For supplying these image data, image data corresponding to three lines is required, and the line memory 105 recording them is required. The image data supplied from the line memory 105 is processed by the arithmetic circuit 106. The arithmetic circuit 106 has an arithmetic circuit configuration executing a function set in the system register 101 and configured by the hard-wired system. Although it is configured by the hard-wired system, calculation algorithms for a lot of image processing can be executed by changing the set contents of the system register 101. A result of the processing of the arithmetic circuit 106 is outputted to the output circuit 107, and one of two flows that the result is supplied to the main memory 209 via the bus interface circuit 108 or that it is written back to the line memory 105 is selected. This select setting can be controlled by the microcontroller 102. The processing result written back to the main memory 209 is managed as, for example, the image data C in FIG. 13 and is used for a processing such as pattern recognition. On the other hand, the processing result written back to the line memory 105 is supplied to the arithmetic circuit 106 again and is used for other processing.

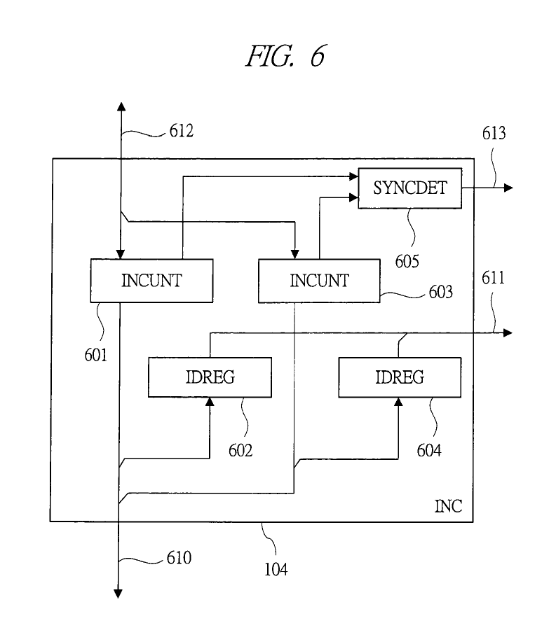

In the image processing system of the present embodiment, the input circuit 104 acquires data from the main memory 209 and records the data in each line of the line memory 105, and the arithmetic circuit 106 performs the image processing. Here, the line memory 105 has a plurality of memory lines which are logically in series as memory regions, and an input data can be written to the memory line assigned by the system register 101 and others and the written data can be read therefrom. More specifically, as illustrated in FIG. 7, the line memory 105 is made up of a memory array (MARY) 70, a data input buffer (DIB) 71, a data output buffer (DOB) 72, and a memory control circuit (MCNT) 73 controlling address and/or access operation status. In FIG. 7, the memory array 70 has memory lines ML0 to MLn. Reference symbols ACUNT0 to ACUNT4 are address counters each functioning as an address pointer to the memory array 70. Values of the address counters ACUNT0 to ACUNT4 become access addresses to the memory array 70. Meaning of each of the address counters ACUNT0 to ACUNT4 will be described later.

The arithmetic circuit 106 calculates data of one or plural memory lines outputted from the line memory in accordance with a processing content assigned by the system register in units of each calculation processing and then outputs the data. For example, for acquiring a processing result corresponding to one pixel with using the data in a local region depending on a processing size such as 3×3 window or 5×5 window, a system of once performing the processing in units of each calculation processing is common, and in this case, the processing is generally performed in units of one line by using the line memory. Therefore, the processing here is handled in the corresponding manner. More specifically, k×k pieces of calculation units UNT and an adder for adding or subtracting a calculation result by each of the calculation units UNT are provided, and such a parallel calculation that i×i pieces of data supplied from i lines of the memory lines are parallelly processed with using i×i pieces of assigned calculation units UNT and their processing results are added and outputted becomes possible.

In FIG. 1, the synchronous circuit 103 receives transfer start and finish of data used for the image processing from the input circuit 104 for each display and each line. Also, it receives a processing result valid signal from the arithmetic circuit 106, generates a synchronous signal for determining a processing start or finish required for the processing in units of line, and outputs the signal to the microcontroller 102. When the processing for one line is finished, a processing content for a next line, a reading position from the line memory, a recording position of a processing result and others are assigned by a setting update of the system register 101 in the microcontroller 102, whereby the processing for the next line is controlled.

At this time, the input circuit 104 references a start address of an image data as a processing target on the main memory 209 recorded in the system register 101 and reads the data in an area of the set address for each one line via the bus interface 108.

The above operations are summarized as follows. That is, the line memory 105 receives data from the input circuit 104, retains a value of the data in accordance with an operation mode set by the system register 101, and outputs the data to the arithmetic circuit 106. The arithmetic circuit 106 receives the data from the line memory 105 and performs a calculation depending on a calculation type set by the system register 101. The output circuit 107 receives the data from the arithmetic circuit 106, performs a shift processing or others if needed, and writes the processing result of the arithmetic circuit 106 back to the line memory 105 or outputs it to the main memory 209 via the bus interface 108 in accordance with the setting of the system register 101. Therefore, the data of the assigned memory line is outputted from the line memory 105 to the arithmetic circuit 106 in units of memory line by the system register 101 and the microcontroller 102, and the arithmetic circuit 106 repeatedly calculates the data of one or plural memory lines outputted from the line memory 105 in accordance with the processing content assigned by the system register 101 in units of each calculation processing.

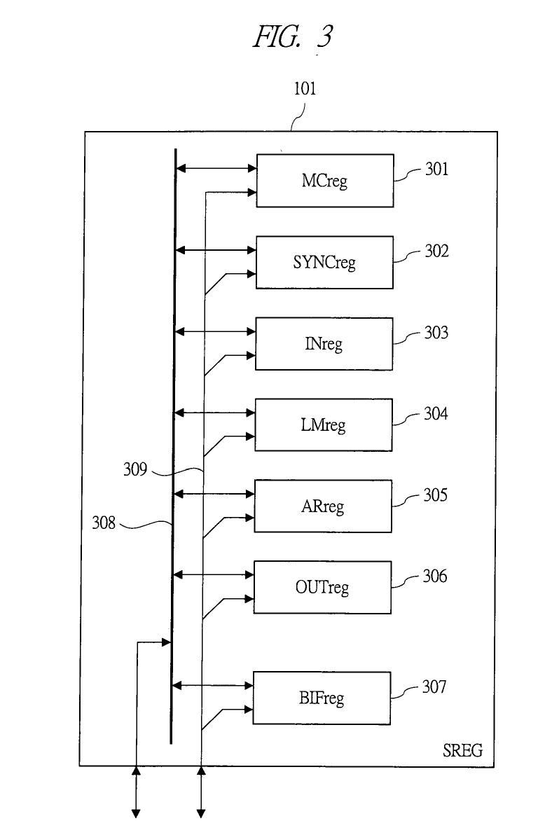

A more specific example of the image processing device will be further described. FIG. 3 is a configuration example of the system register 101. In FIG. 3, the system register 101 has a microcontroller setting register (MCreg) 301, a synchronous circuit setting register (SYNCreg) 302, an input circuit setting register (INreg) 303, a line memory setting register (LMreg) 304, an arithmetic circuit setting register (ARreg) 305, an output circuit setting register (OUTreg) 306, and a bus interface setting register (BIFreg) 307. A reference symbol 308 denotes a data bus and a reference symbol 309 denotes an address bus, and they indicate writing paths for each register. The illustration of control signal paths through which control data set to each register is transmitted to corresponding internal circuits as control signals is omitted.

The microcontroller setting register 301 is a register for instructing the operation start or the like of the microcontroller 102 and acquiring status information of the microcontroller 102.

The synchronous circuit setting register 302 is a register for instructing the operation start or synchronization (wait) to a target whose synchronization is to be monitored. In the present embodiment, the processing is performed for each line, and the processing content and a destination for recording the calculation result can be changed in each processing. Settings to a function of recognizing a processing start or finish required for the change for each line are performed.

The input circuit setting register 303 is a register for retaining a value required for generating an address to be outputted to the main memory 209 by the input circuit 104. More specifically, settings of a position in the main memory 209 where the image data of the processing target is stored, the number of pixels in a lateral direction and a vertical direction of the image data to be processed, and others are performed.

The line memory setting register 304 is a register for performing a configuration control of the line memory. The line memory 105 does not always use the line memory depending on the processing content or the processing system. A general-purpose image processing device is assumed in the present embodiment, and required settings such as how to use the line memory, whether the control of the microcontroller is allowed or not, and others are performed.

The arithmetic circuit setting register 305 is a register for setting the calculation type, and it includes the image processing functions and parameters required for each image processing. Also, as for a part of processing results, there is a register for storing the processing result of the arithmetic circuit 106.

The output circuit setting register 306 is a register for switching whether the calculation result is outputted to the line memory 105 or to the outside via the bus interface BIF or assigning the instruction of the processing of shift down of the calculation result. In the bus interface setting register 307, settings required for the operation of the bus interface are performed.

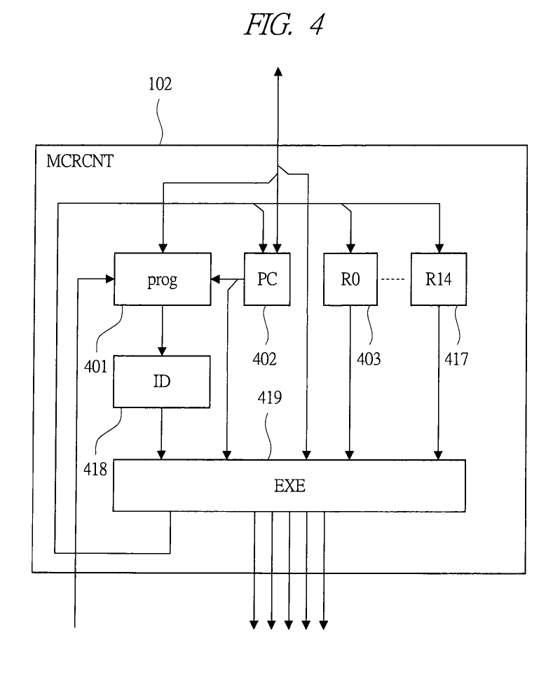

FIG. 4 illustrates a configuration example of the microcontroller 102. In FIG. 4, a reference symbol 401 denotes a micro-program retaining circuit (prog), a reference symbol 402 denotes a program counter (PC), reference symbols 403 to 417 denote registers R0 to R14, a reference symbol 418 denotes a command decoder (ID), and a reference symbol 419 denotes an execution circuit (EXE). The microcontroller 102 can access the system register 101 by programs to control the line memory 105, select the functions of the image processing, set the parameters, and select the storing positions of the output data. The microcontroller 102 determines the controlling content for each line and combines various processing, so that functions of the arithmetic circuit 106 implemented by the hard-wired system are significantly extended.

The micro-program retaining circuit 401 is a circuit for reading a micro-program from the main memory 209 and retaining it. The program counter 402 is a pointer indicating a currently executed address of programs stored in the micro-program retaining circuit 401. The registers 403 to 417 are registers referenced in the micro-program, and some of them are used in general purpose and others have specific functions. The command decoder 418 is a circuit for interpreting a currently executed command. The execution circuit 419 is a circuit for generating the control signal based on the command interpretation and generating an update value of a register.

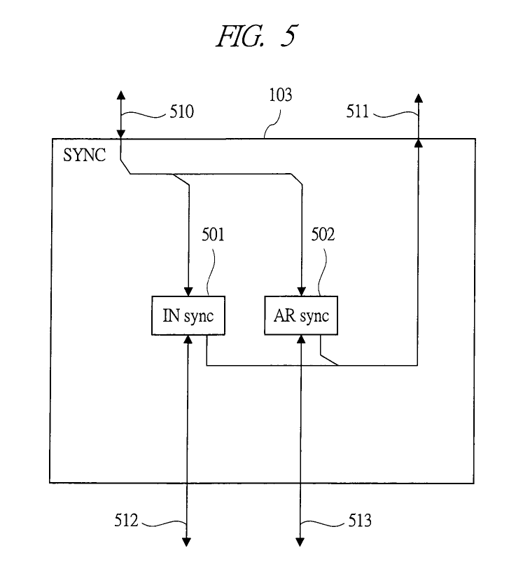

FIG. 5 illustrates a configuration example of the synchronous circuit 103. In FIG. 5, a reference symbol 501 denotes an input synchronous circuit (INsync), and a reference symbol 502 denotes an arithmetic processing synchronous circuit (ARsync). A reference symbol 510 represents an interface signal from/to the microcontroller 102 and the system register 101, and a reference symbol 511 represents an interface signal from/to the microcontroller 102. A reference symbol 512 represents an interface signal from/to the input circuit 104, and a reference symbol 513 represents an interface signal from/to the arithmetic circuit 106.

The input synchronous circuit 501 is a circuit for monitoring the set synchronization of the input circuit 104. The input circuit 104 is a circuit reading the data corresponding to one line from the main memory 209. By the instruction to the input circuit 104, the operation of reading the data corresponding to one line can be started. Also, when finish of reading the data for one line is detected by the input circuit 104, it is transmitted to the microcontroller 102 as an interrupt request or the like.

The arithmetic processing synchronous circuit 502 is a circuit for monitoring the set synchronization of the arithmetic circuit 106. In order to enable the calculation in units of one line in the arithmetic circuit 106, start of the calculation for one line is instructed by the arithmetic processing synchronous circuit 502. When finish of the calculation for one line is detected, it is transmitted to the microcontroller 102 by the arithmetic processing synchronous circuit 502 as an interrupt request or the like.

FIG. 6 illustrates a configuration example of the input circuit 104. In FIG. 6, reference symbols 601 and 603 denote counters (INCUNT), reference symbols 602 and 604 denote input data retaining circuits (IDREG), and a reference symbol 605 denotes a synchronous determining circuit (SYNCDET). The counters 601 and 603 are counters counting up from an initial value to a final value set in advance, and the values are outputted as addresses for the read access to the main memory 209. An address of a display head (or line head) to be the target of the image processing is initially set in the counters 601 and 603, and a memory address of the image data on the main memory 209 is generated by sequentially performing an increment operation with using the address as the initial value. The data read from the main memory 209 by the generated memory address is sequentially retained in the input data retaining circuits 602 and 604. The synchronous determining circuit 605 determines whether the data for one line is retained in the input data retaining circuits 602 and 604 or not from the memory address, and transfers the determination result to the synchronous circuit 103, so that data can be loaded to the line memory 105 in units of memory line. Here, a reason why each of the pair of the input data retaining circuits 602 and 604 and the pair of the counters 601 and 603 is provided is that calculations between different images are required depending on the image processing. When the line memory has a pair of hardwares that can be operated in parallel, the calculation processing can be executed while parallelly storing the different images in the line memory. A reference symbol 612 representatively denotes a signal line connected to the microcontroller 102 and the system register 101, a reference symbol 613 representatively denotes a signal line connected to the synchronous circuit 103, a reference symbol 611 representatively denotes a signal line connected to the line memory, and a reference symbol 610 representatively denotes a signal line connected to the bus interface 108.

FIG. 7 illustrates a configuration example of the line memory 105. The scales of the memory lines ML0 to MLn are logically variable, and for example, a configuration of 1024 bytes×4 lines or 128 bytes×32 lines can be selected. In the calculation processing mode, initial values of a position (memory line) to which data from the outside of the line memory is written and a position (memory line) of data outputted outside the line memory are set by the system register 101 controlled by the microcontroller 102. Also, addresses on the line each indicating the writing position on the line and others are assigned by the counters ACUNT0 to ACUNT4 in the line memory depending on its operation type. The line memory is generally made up of a dual port memory that can read and write in parallel, so that it can write the processing result while reading the image data. The control of the address generation and the operation mode required for the parallel operation is performed by an access controller 73. The access controller 73 can select an operation type in which the memory lines ML0 to MLn execute a simple FIFO operation, and the selection is determined by the setting of the system register 101.

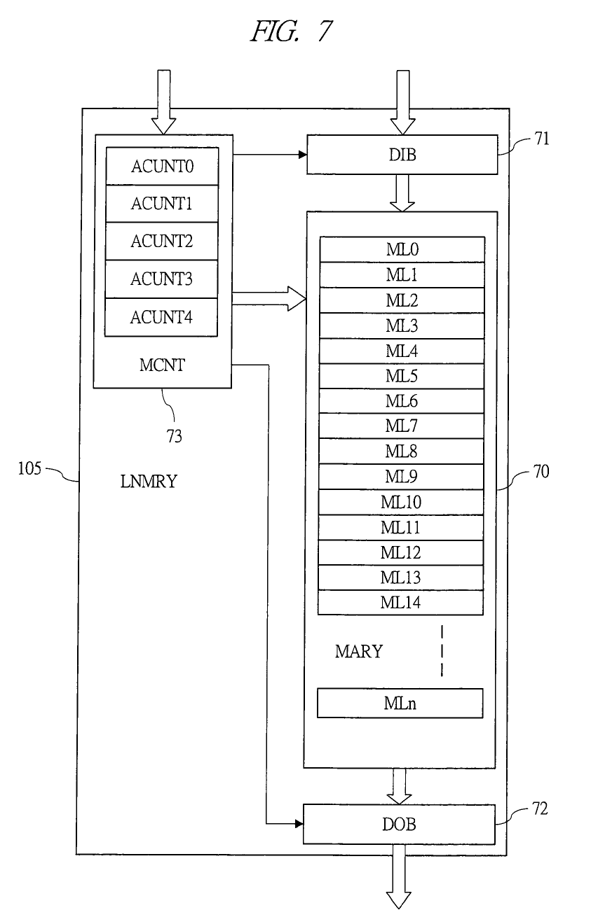

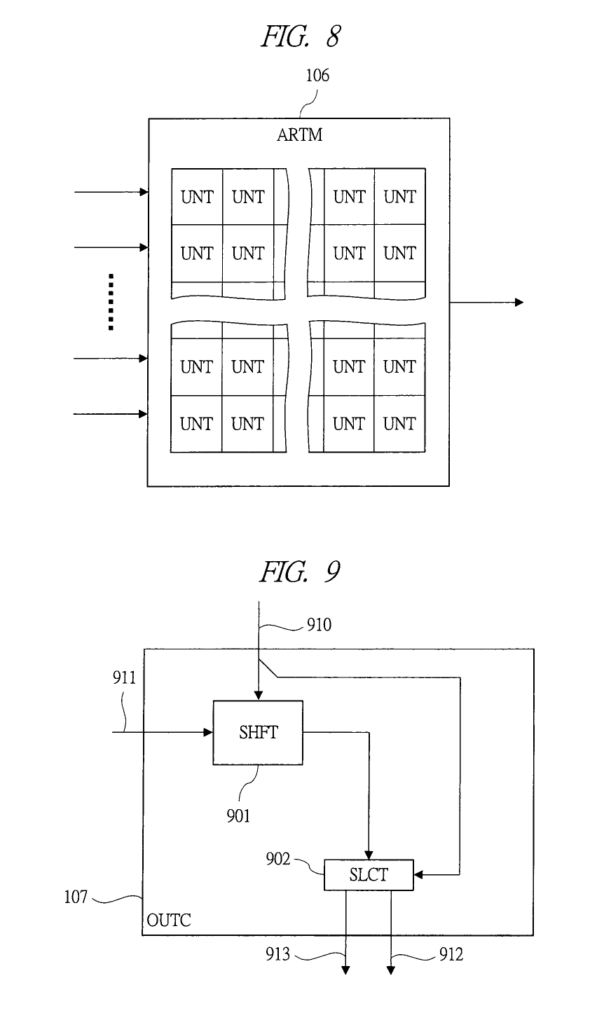

FIG. 8 illustrates a configuration example of the arithmetic circuit 106. In a normal image processing mode, the arithmetic circuit 106 can perform the 3×3-filter operation or 5×5-filter operation for the image processing calculation. In FIG. 8, one rectangle indicates a circuit performing one calculation function (calculation unit UNT), and for example, one calculation unit UNT block can execute a product-sum operation in the filter processing. The setting of the image processing function and the parameter setting are controlled by the system register 101, and various types of processing can be implemented. Also, in the calculation processing mode, when the configuration of the arithmetic circuit for the above-described filter operation is logically changed so as to provide, for example, 25 pieces (5×5) of product-sum circuits, up to 25 parallel product-sum operations are possible. Although the arithmetic circuit 106 is generally implemented by the hard-wired logic system, a general-purpose image processing function can be achieved by implementing the configuration of the line memory, the parameters of the filter, dedicated hardwares, and others. Its circuit scale can be achieved with a hardware quantity sufficiently smaller than that of the case where the same performance is achieved by mounting a plurality of general-purpose processors.

FIG. 9 illustrates a configuration example of the output circuit 107. The output circuit 107 has a shifter (SHFT) 901 and a selector (SLCT) 902. A reference symbol 910 representatively denotes a signal line connected to the microcontroller 102 and the system register 101. A reference symbol 911 representatively denotes a signal line for receiving the calculation result of the arithmetic circuit 106. A reference symbol 912 denotes a connecting path to the buffer interface 108, and a reference symbol 913 denotes a writing-back path to the line memory 105. The shifter 901 is a circuit for performing the shift down of the calculation result. For example, when a calculation of 8 bits×8 bits is performed, its result becomes 16 bits, and when it is required to obtain the result as a numerical value of 8 bits or the like, the shifter is used for that. The selector 902 is a circuit selecting whether the calculation result is written back to the line memory 105 or written back to the main memory 209 via the bus interface 108. Here, by achieving the function of writing the processing result back to the line memory 105 for each line, the processing result can be used as a result in the middle of the calculation, so that advanced image processing can be achieved when basic image processing functions are combined by the microcontroller 102.

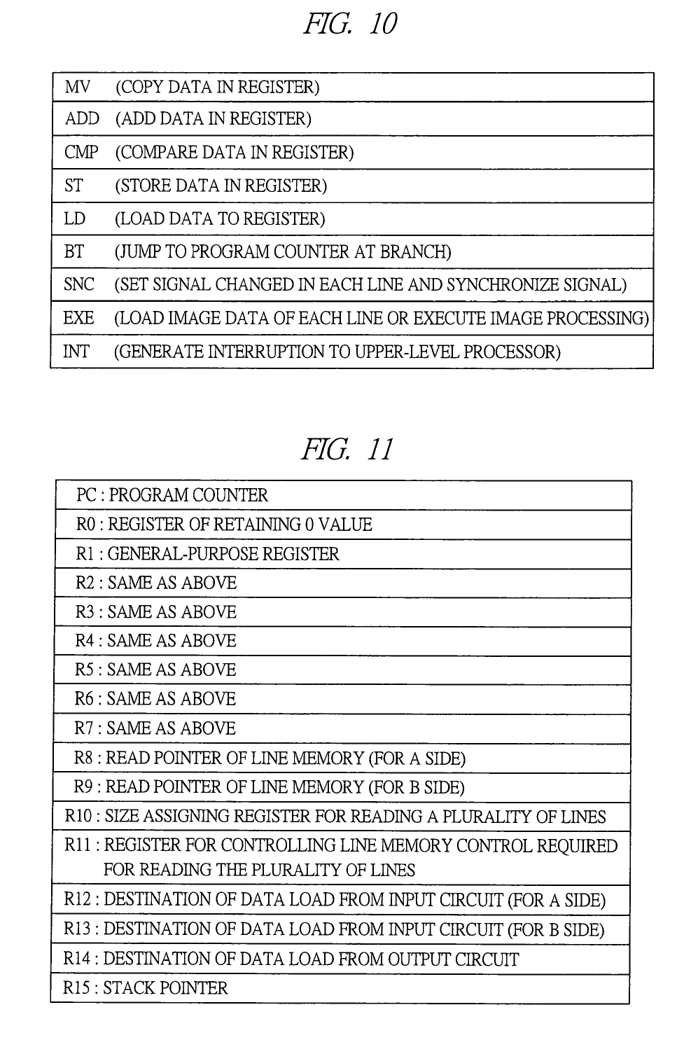

In FIG. 10, a command set of the microcontroller is extracted.

An MV command is a transfer command of data. Data is transferred from a register for a first operand to a register for a second operand, a value is transferred to a register, or a value of a register is transferred to an address shown by a label, respectively. The command is used for a data copy or others.

An ADD command is a command for calculating the sum of values of the register for the first operand and the register for the second operand and substituting the sum to the register for the second operand. The command is used for a data addition of registers or others.

A CMP command is a command for comparing (taking a difference of) the values of the register for the first operand and the register for the second operand and reflecting whether the values are equal or not on a condition flag. The condition flag is used in a branch command described later.

An ST command is a command storing data of a register and is a command for writing a value of the register to an address in a register space which the image processing device can access.

An LD command is a command for loading data to a register and is a command for reading the value, which is recorded in the address in the register space which the image processing device can access, to an assigned register.

A BT command is a command for brunching data to a set address when the condition flag described above is true.

An SNC command is a command for setting a signal changed for each line to acquire the synchronization, and it can be used for acquiring the synchronization for switching the calculation function for each line. More specifically, it is a command for describing a function block performing a synchronous processing to the operand, thereby monitoring a synchronization in which the processing of the described function block is finished in units of line. Until finishing the operation of the target in units of line, execution of a micro-program is waited. Note that the function block mentioned here indicates the input circuit or the arithmetic circuit. For example, in a circuit performing the image processing, the command is used for waiting the finish of the execution to the data in units of one line.

An EXE command is a command for describing the function block to the operand, thereby executing the processing in units of line by the function block of the described target. This is a command used for loading the image data or executing the image processing in units of memory line, and it can be regarded as a command instructing the execution in units of one line in the circuit performing the image processing.

An INT command is a command for generating an interruption to the CPU 208 on an upper level according to need by the microcontroller 102. The upper-level CPU 208 performs a processing of image recognition, and it is independently operated from the image processing device 201. Therefore, after a request for the image processing is generated in the upper-level CPU 208 and the image processing device 201 performs the image processing, the image processing device 201 is required to notify the CPU 208 of the finish of the image processing. By generating the notification by the microcontroller 102 with using a program operation, more efficient parallel processing is possible. For example, since the finish notification is conventionally performed by hardware, the notification cannot be performed at the timing other than that designed in advance. Since it is difficult to consider all of assumed image processing in advance in the design stage, there is a possibility that new functions cannot be handled to cause waste. In this example, various calculations can be implemented by the control of the micro-program. Further, it is possible to program appropriate processing such as executing the condition branch or the like and generating the interruption to the upper-level CPU 208 at a certain moment, thereby canceling the processing to the image processing result or the ongoing calculation execution. For example, when the CPU 208 and the image processing device 201 have to independently execute the processing, the image processing device notifies arbitrary status in the processing to the CPU 208, and the CPU 208 can start the access to the processing result without waiting the calculation finish of the image processing device 201.

FIG. 11 illustrates register functions usable by a program of the microcontroller. In order to enable the microcontroller 102 to change the function of the arithmetic circuit 106 for each line, registers for recording information of a memory access to each memory line, a setting of calculation functions of the image processing, the number of lines of data required for the calculations of the image processing, and others are provided. A reference symbol PC denotes a program counter and is a special register indicating a position of a currently executed command. Reference symbols R0 to R7 are general-purpose registers and are registers usable for the retention of temporary data in the micro-program. A reference symbol R8 is a register for a read pointer of the line memory and is a register on an A side of a source. A reference symbol R9 is a register for a read pointer of the line memory and is a register for a B side of the source. A reference symbol R10 is a register assigning an information volume for previously recording data required for the image processing in the line memory. A reference symbol R11 is a register for recording the data required when a plurality of lines of the image data required for the image processing are provided and it is recognized by the micro-program. For example, the data may include the required number of lines or a line position of a line memory currently read. A reference symbol R12 is the A side of a destination of loading data from the input circuit 104, and a reference symbol R13 is the B side of the destination of loading data from the input circuit 104. A reference symbol R14 is a destination of loading data from the output circuit 107. A reference symbol R15 is a stack pointer.

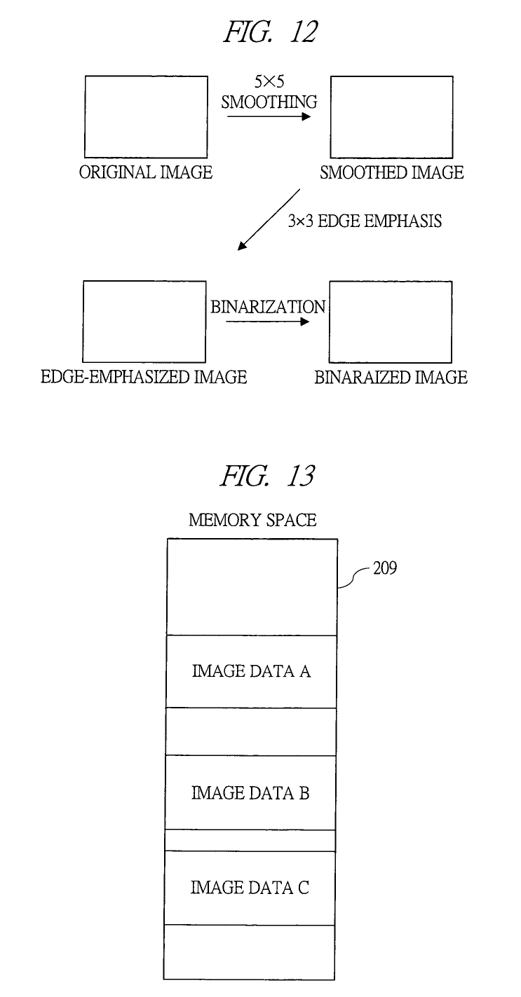

FIG. 12 illustrates a flow of an image recognition processing as one example of a processing using the image processing device 201. In FIG. 12, a smoothing processing of 5×5 window is performed to an original image for the purpose of noise reduction, and an edge emphasis processing is performed to its resultant image. The edge emphasis processing is performed by 3×3 window. Finally, a binarization processing is performed to the edge-emphasized image, so that outline (edge) of an object is extracted. Such a processing is a series of processing performed often in the image recognition. The smoothing processing is performed by the convolution operation of averaging pixel values of the image data of 5×5 window to provide a center pixel value. In the smoothing processing, the data of 5×5 window becomes the data serving as the unit of the calculation processing.

FIG. 14 illustrates a status of use of the line memory in the image processing of FIG. 12. The data of the original image is stored in five lines of the memory lines MLi to MLi+4 in the line memory 105 to perform the 5×5 smoothing processing, three lines of the memory lines MLj to MLj+2 of the line memory 105 are used for storing the smoothed processing result to perform the edge emphasis in units of each 3 line, and the memory line MLk is used for storing the edge-emphasized image data to perform the binarization in units of the memory line MLk. The binarized image data is stored in the memory line MLm and following lines in units of line, and the data is transferred to the main memory 209 at a required timing.

For example, when pixel data lines PXL0 to PXL4 are stored in the memory lines MLi to MLi+4, respectively, the convolution operation for the 5×5 smoothing processing is performed to the pixel data lines, and the calculation results are stored in the memory line MLj as image data of the center pixel, and then, the convolution operation is sequentially performed while shifting the 5×5 calculation processing unit toward a right direction one pixel by one pixel, so that their calculation results are stored in a pixel position next to the memory line MLj. The calculation like this is performed to the right end of the memory lines MLi to MLi+4. In this state, a smoothed data CMB2 in the pixel data line PXL2 is acquired in the memory line MLj. Next to this, the unnecessary data of the pixel data line PXL0 is invalidated and the data of the next pixel data line PXL5 is stored in the memory line MLi, and the smoothing processing is similarly performed to the pixel data lines PXL1 to PXL5 this time, so that a smoothed data CMB3 in the pixel data line PXL3 is acquired in the memory line MLj+1. Also next to this, the unnecessary data of the pixel data line PXL1 is invalidated and the data of the next pixel data line PXL6 is stored in the memory line MLi+1, and the smoothing processing is similarly performed to the pixel data lines PXL2 to PXL6 this time, so that a smoothed data CMB4 in the pixel data line PXL4 is acquired in the memory line MLj+2.

Since the smoothed data CMB2 to CMB4 corresponding to 3 pixel lines are acquired, the calculation for the 3×3 edge-emphasis processing is performed to the smoothed data, and their calculation results are stored in the memory line MLk as image data of their center pixel, and then, the calculation for the edge-emphasis processing is sequentially performed while shifting the 3×3 calculation processing unit toward a right direction one pixel by one pixel, so that their calculation results are stored in a pixel position next to the memory line MLk. The calculation like this is performed to the right end of the memory line MLk. In this state, the edge-emphasized data EMP3 in the pixel data line PXL3 is acquired in the memory line MLk.

Since the edge-emphasized data EMP3 is acquired, the binarization is performed to the edge-emphasized data this time, and its result is stored in the memory line MLm. By sequentially repeating the above-described operations, binarized data is accumulated in the memory line MLm and following lines.

In the above-described processing, the address counters ACUNT0 and ACUNT1 in FIG. 7 function as write pointers generating addresses for sequentially writing the pixel data toward the right direction in the memory lines MLi to MLi+4. The reason why the two counters ACUNT0 and ACUNT1 are provided is that the case where the image data of a plurality of windows is parallelly written is assumed. The address counter ACUNT2 functions as a read pointer generating an address for sequentially reading the image data of 5 pixels toward the right direction from the memory lines MLi to MLi+4. The address counter ACUNT3 functions as an address pointer generating a pixel position in the memory line MLj to which the smoothed data is sequentially written. The address counter ACUNT4 functions as a read pointer generating an address for sequentially reading the image data of 3 pixels toward the right direction from the memory lines MLj to MLj+2. In addition to them, address counters functioning as a write pointer and a read pointer for the memory lines MLk, MLm and others are provided though their illustrations are omitted. The assignation of the memory line is determined by the setting to the system register 101.

Note that the calculation result of the binarization processing may be directly outputted from the output circuit to the main memory 209. At this time, the binarized calculation result is temporarily accumulated in the shifter 901 of the output circuit 107, and when the data for one line is accumulated, the writing operation is performed to the main memory 209.

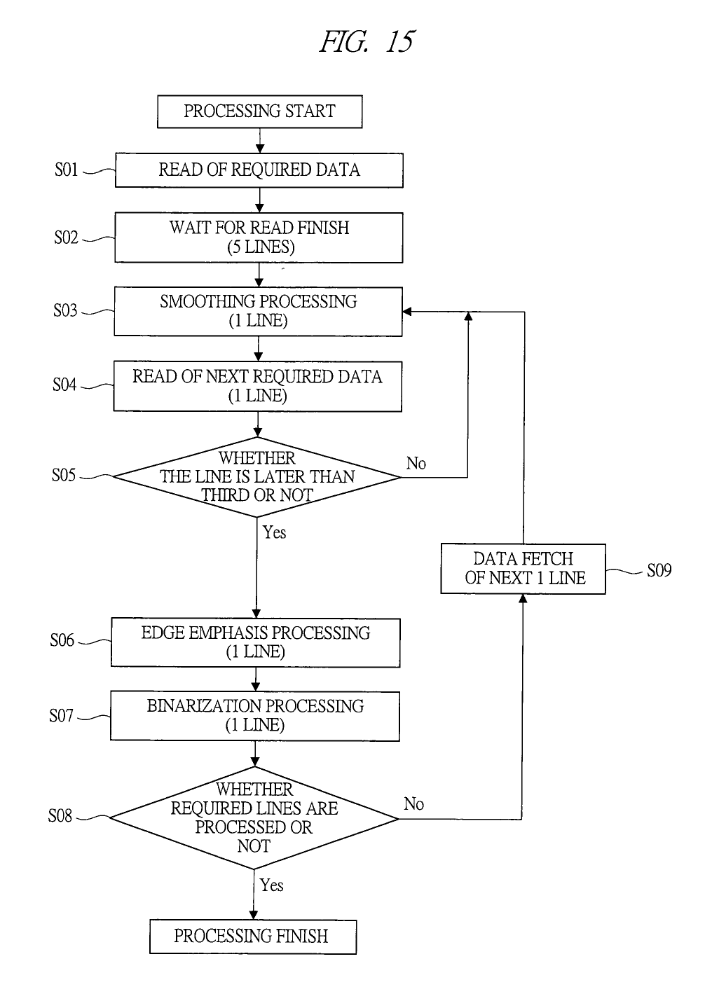

FIG. 15 illustrates a processing flow controlled by the micro-program described in the present embodiment. Before starting the process, the micro-program is stored in the micro-program retaining circuit 401 by the control of the CPU 208. Then, at a step of performing the image processing, the CPU 208 performs the start instruction by the register setting to start the processing. An initial command described in the micro-program starts to store the image data of the processing target to 5 memory lines of the line memory for performing the smoothing processing of 5×5 window. Here, the data is read from an address of the processing start assigned by the input circuit 104 (S01), and the data is stored in an address of a line memory assigned by the registers R12 and R13 described in FIG. 11. The microcontroller 102 waits for input of five lines by the command SNC (see FIG. 10) for synchronization. At this time, both of a program of waiting for each one line and a program of waiting for five lines at a time are available. When a processing step of waiting for the finish of reading of five lines is finished (S02) and data for the smoothing processing of 5×5 window is stored in the line memory, the smoothing processing is started (S03). At this time, the microcontroller 102 sets the image processing function processed by the arithmetic circuit 106 to the smoothing processing with using commands such as MV and LD. After the microcontroller starts the processing, it waits for the finish of one line again by the command SNC for synchronization. The result of the smoothing processing is stored in a line memory assigned by R14 in FIG. 11. During the smoothing processing for one line, next one line is read (S04). Since the next processing is the edge-emphasis processing of 3×3 window requiring the data of three lines, the smoothing processing is repeated one line by one line until processing of three lines is finished (S05). Since the edge-emphasis processing is possible at a step of finishing the processing of three lines, the microcontroller 102 changes the function of the arithmetic circuit 106 to the edge-emphasis processing with using a command of the register access to execute the edge-emphasis processing for one line (S06). Also at this time, similarly to the setting of the smoothing processing, the edge-emphasized result is stored in a line memory set by the register of R14. With respect to the result of the edge-emphasis processing, the microcontroller 102 changes the function of the arithmetic circuit 106 to the binarization processing again to perform the processing (S07). The processing result is stored in the main memory RAM 209 via the output circuit 107. In this manner, the series of processing for one line is finished. If the processing is not performed to all required lines (No at S08), the microcontroller 102 stores data of next one line from the main memory RAM 209 in the line memory again (S09). If all of this data are already read, since the smoothing processing of 5×5 window can be executed, the smoothing processing is started at the time when data for new five lines are acquired. At the step where the smoothing processing for one line is done, the data for three lines of the edge-emphasis processing is already stored, and it means that the next processing is ready, and therefore, the microcontroller switches the function of the arithmetic circuit 106 to execute the edge-emphasis processing. Further, the binarization processing is continuously executed, and a processing result for new one line is stored in the main memory RAM 209. Since the processing for one line is finished here, the same processing is repeated again, and whether processing has been done for a required number of lines or not is checked (S08), and the processing is continued. When processing has been done for a required number of lines, the processing is finished, and the interruption is generated to the CPU 208 by the INT command in FIG. 10 to notify the finish of the series of image processing.

As described above, data is inputted to the line memory 105 from the outside with a restriction of “in units of memory line”, and the number of memory lines and positions of the same to which data is inputted can be programmable by the setting value of the system register 101 and the control circuit of the microcontroller 102. The arithmetic circuit 106 is subjected to the restriction of performing the calculation in units of data of one or plural memory lines supplied from the line memory 105, and a calculation processing content in units of calculation processing for the units of data can be programmably assigned by the control circuit. Therefore, the image processing device 201 can simultaneously achieve a highly efficient processing based on the hard-wired logic system and a flexible processing of a general-purpose processor.

In the foregoing, the invention made by the present inventors has been concretely described based on the embodiment. However, it is needless to say that the present invention is not limited to the foregoing embodiment and various modifications can be made within the scope of the present invention.

For example, although the image recognition has been described as one example of the image processing above, the present invention is not limited to this. Also, although the smoothing, edge-emphasis, binarization are taken as one example of the image recognition processing, the present invention is not limited to this, either. The image processing device may be configured as an accelerator of one chip. A circuit module mounted on a chip of a system LSI is not limited to that in FIG. 1.

What is claimed is:

1. An image processing device comprising:
an input circuit for reading data to be a calculation target from an outside and inputting it;
a buffer memory temporarily retaining data inputted by the input circuit;
an arithmetic circuit performing a calculation processing of data outputted from the buffer memory;
an output circuit for writing a calculation result of the arithmetic circuit back to the outside or the buffer memory; and
control circuits, wherein
the buffer memory has a plurality of memory lines which are logically in series as memory regions, and input data can be written to the memory line assigned by the control circuit and the written data can be read therefrom,
the arithmetic circuit repeatedly calculates data of one or plural memory lines outputted from the buffer memory in accordance with a processing content assigned by the control circuit in units of each calculation processing, and
data of the assigned memory line is outputted from the buffer memory to the arithmetic circuit in units of each memory line by the control circuits.

2. The image processing device according to claim 1, wherein
the control circuit instructs one or plural memory lines to which the data inputted from the outside is written, and instructs the memory line to which the calculation result of the arithmetic circuit is written back.

3. A data processor comprising:
an image processing device; and
a central processing unit performing control of the image processing device and access control to a memory, wherein
the image processing device has:
an input circuit for reading data to be a calculation target from the memory and inputting it;
a buffer memory temporarily retaining data inputted by the input circuit;
an arithmetic circuit performing a calculation processing of data outputted from the buffer memory;
an output circuit for writing a calculation result of the arithmetic circuit back to the memory or the buffer memory; and
control circuits,
the buffer memory has a plurality of memory lines which are logically in series as memory regions, and input data can be written to the assigned memory line and the written data can be read therefrom,
the arithmetic circuit repeatedly calculates data of one or plural memory lines outputted from the buffer memory in accordance with an assigned processing content in units of each calculation processing, and
the control circuit instructs one or plural memory lines to which data inputted from the input circuit is written, instructs the calculation processing content of the arithmetic circuit, instructs the memory line to which a calculation result of the arithmetic circuit is written back, and instructs a memory line supplying data from the buffer memory to the arithmetic circuit.

4. The data processor according to claim 3, wherein
the central processing unit references a calculation result of the image processing device from the memory during a calculation operation of the image processing device.

5. A data processor comprising: an image processing device; and a memory, wherein
the image processing device has:
an input circuit for reading data to be a calculation target from the memory and inputting it;
a buffer memory temporarily retaining data inputted by the input circuit;
an arithmetic circuit performing a calculation processing of data outputted from the buffer memory;
an output circuit for writing a calculation result of the arithmetic circuit back to the memory or the buffer memory; and
control circuits,
the buffer memory has a plurality of memory lines which are logically in series as memory regions, and input data can be written to the memory line assigned by the control circuit and the written data can be read therefrom,
the arithmetic circuit can parallelly calculate data of the plurality of memory lines read from the buffer memory in accordance with a processing content assigned by the control circuit, and
the control circuit controls the arithmetic circuit to repeatedly execute a first calculation for data in a first memory region corresponding to the plurality of memory lines of the buffer memory sequentially in units of each data processing, and when calculation results of the repeatedly-executed first calculations are stored in memory lines in a second memory region corresponding to the plurality of memory lines of the buffer memory, the control circuit replaces data of a memory line where the data memory is performed first in the first memory region, and then, controls the arithmetic circuit to repeatedly execute the first calculation again.

6. The data processor according to claim 5, wherein,
when required calculation results are acquired in the memory lines in the second memory region, the control circuit controls the arithmetic circuit to repeatedly execute a second calculation for data in the second memory region sequentially in units of each data processing, and to store calculation results of the repeatedly-executed second calculations in a memory line in a third memory region of the buffer memory.

7. The data processor according to claim 6, wherein,
when required calculation results are acquired in the memory line in the third memory region, the control circuit controls the arithmetic circuit to repeatedly execute a third calculation for data in the third memory region, and to store calculation results of the repeatedly-executed third calculations in a memory line in a fourth memory region of the buffer memory.

8. The data processor according to claim 7, wherein,
when required calculation results are acquired in the memory line in the fourth memory region, the control circuit controls a writing of the calculation results to the memory by instructing the output circuit.

9. The data processor according to claim 6, wherein,
when required calculation results are acquired in the memory line in the third memory region, the control circuit controls the arithmetic circuit to repeatedly execute a third calculation for data in the third memory region, and controls the output circuit to output the calculation results of the repeatedly-executed third calculations to the outside.

10. The data processor according to claim 5, wherein
the control circuit has a microcontroller, a control register, and a synchronous circuit,
the microcontroller performs a control to execute a program to write control data to the control register,
the synchronous circuit controls the writing to the control register in accordance with operation statuses of the input circuit and the arithmetic circuit, and
the control register outputs control signals to the input circuit, the buffer circuit, the arithmetic circuit, and the output circuit in accordance with the written control data.

11. The data processor according to claim 10, wherein
control information for assigning a memory line to which data is loaded from the input circuit, control information for assigning a memory line to which data is loaded from the output circuit, control information for assigning the number of memory lines to which data is loaded, control information for assigning a memory line from which data is outputted, and control information for assigning the number of memory lines from which data is outputted are set to the control register.

12. The data processor according to claim 7, wherein
the first calculation is a convolution operation for smoothing image data of the plurality of memory lines, with using m×n pixels of data as a unit of data processing.

13. The data processor according to claim 12, wherein
the second calculation is a filter operation for edge-emphasizing the image data of the plurality of memory lines, which has been subjected to the convolution operation, with using i×j pixels of data as a unit of data processing.

14. The data processor according to claim 13, wherein
the third calculation is an operation for binarizing the image data which has been subjected to the filter operation.
